(19) United States
(12) Patent Application Publication
(10) Pub. No.: US 2015/0069938 A1
(43) Pub. Date: Mar. 12, 2015

(54) HYBRID VEHICLE AND METHOD FOR CONTROLLING HYBRID VEHICLE

(71) Applicant: TOYOTA JIDOSHA KABUSHIKI KAISHA, Toyota-shi (JP)

(72) Inventor: Taishi HISANO, Nisshin-shi (JP)

(21) Appl. No.: 14/456,517

(22) Filed: Aug. 11, 2014

(30) Foreign Application Priority Data
Sep. 6, 2013 (JP) 2013-185023

(51) Int. Cl. H02P 3/14

(52) U.S. Cl. CPC H02P 3/14
USPC 318/377

(57) ABSTRACT

An ECU sets a regenerative braking force generated by a second motor generator during an off-state of an accelerator to be larger in a case where a regeneration level is high than in a case where the selected regeneration level is low, thereby increasing a power generation amount of the second motor generator. The ECU sets a charging amount from first motor generator to battery during operation of an engine to be larger in a case where the regeneration level lower than the default level is selected by regeneration level selector than a case where the regeneration level is not selected by regeneration level selector.

This nonprovisional application is based on Japanese Patent Application No. 2013-185023 filed on Sep. 6, 2013 with the Japan Patent Office, the entire contents of which are hereby incorporated by reference.

### BACKGROUND OF THE INVENTION

1. Field of the Invention

The present invention relates to a hybrid vehicle and a method for controlling a hybrid vehicle, and more particularly to a hybrid vehicle and a method for controlling a hybrid vehicle having a function of allowing a driver to select a regeneration level.

2. Description of the Background Art

Conventionally, there has been known a hybrid vehicle allowing a driver to select a braking level during regeneration.

For example, according to a hybrid vehicle disclosed in Japanese Patent Laying-Open No. 2012-218697, during regenerative braking with use of a second motor generator, the second motor generator sets regeneration levels in stages in accordance with a user's operation to a paddle switch. Accordingly, a user can experience feeling equivalent to feeling of reduction in speed which occurs in accordance with transmission operation in automatic transmission.

### SUMMARY OF THE INVENTION

However, when a driver sets a low regeneration level to improve fuel consumption, a charging amount of a battery during regenerative braking is reduced. Consequently, since the SOC of the battery is lowered, it would be necessary to start an engine, thereby deteriorating the fuel consumption on the contrary to the driver's intention.

Therefore, an object of the present invention is to provide a hybrid vehicle and a method for controlling a hybrid vehicle capable of preventing deterioration in fuel consumption caused by setting a low regeneration level.

A hybrid vehicle of the present invention includes an internal combustion engine, a first motor generator which generates electric power through driving of the internal combustion engine, a second motor generator which drives the hybrid vehicle and generates electric power through regenerative braking, a power storage device which is configured to enable supply and reception of electric power between the first motor generator and the second motor generator, and a selector which selects a regeneration level of the second motor generator in accordance with a driver's operation. A regeneration level of the second motor generator is maintained at a default level when a regeneration level is not selected by the selector. The hybrid vehicle includes a control device which increases a power generation amount of the second motor generator by setting a regenerative braking force generated by the second motor generator during an off-state of an accelerator to be larger in a case where the regeneration level is high than in a case where the regeneration level is low. The control device sets a charging amount from the first motor generator to the power storage device during operation of the internal combustion engine to be larger in a case where a regeneration level lower than a default level is selected by the selector than in a case where a regeneration level is not selected by the selector.

In the case where a state with a low regeneration level is selected, the regenerative power generation amount during the off-state of the accelerator becomes small. Therefore, when the remaining capacity of the power storage device is excessively lowered due to a use of an auxiliary machine or the like, the internal combustion engine may be started. Thus, the fuel consumption is deteriorated. With the configuration described above, the charging amount to the power storage device is set to be large during operation of the internal combustion engine when a regeneration level lower than a default level is selected by the selector. Consequently, when a regeneration level lower than a default level is selected, starting of the internal combustion engine due to a small recovery amount of the remaining capacity of the power storage device in the off-state of an accelerator can be prevented.

Preferably, under a condition that a remaining capacity of the power storage device is equal, the control device sets a requested charging amount of the power storage device during operation of the internal combustion engine to be larger in a case where a regeneration level lower than a default level is selected by the selector than in a case where a regeneration level is not selected by the selector.

Accordingly, the remaining capacity of the power storage device can be set large appropriately during operation of the internal combustion engine.

Preferably, in a case where a plurality of regeneration levels lower than the default level are provided which can be selected by the selector, and the plurality of regeneration levels include a first level and a second level higher than the first level, the control device sets a charging amount from the first motor generator to the power storage device during operation of the internal combustion engine to be larger in a case where the first level is selected than in a case where the second level is selected.

As the selected regeneration level is lower, the regenerative power generation amount during the off-state of the accelerator becomes smaller. With the configuration described above, since the charging amount to the power storage device during operation of the internal combustion engine becomes larger as the regeneration level is smaller, starting of the internal combustion engine due to a small recovery amount of the remaining capacity of the power storage device in the off-state of an accelerator can be prevented.

Preferably, the control device changes an output of the internal combustion engine in accordance with the selected regeneration level so that a driving force of the hybrid vehicle does not change in accordance with the selected regeneration level during operation of the internal combustion engine.

Accordingly, even though a charging amount to the power storage device is changed in accordance with the selected regeneration level during operation of the internal combustion engine, a driving force of a vehicle can be maintained constant.

Preferably, the hybrid vehicle includes a power split mechanism which is configured to distribute a driving force from the internal combustion engine to first motor generator and a drive shaft of a vehicle. The first motor generator can generate electric power by receiving a driving force from the internal combustion engine. The second motor generator is coupled to the drive shaft.

Accordingly, the charging amount from the first motor generator to the power storage device is set larger during operation of the internal combustion engine as the regeneration level is lower. Consequently, when a regeneration level lower than a default level is selected, starting of the internal combustion engine due to a small recovery amount of the remaining capacity of the power storage device in the off-state of an accelerator can be prevented.

In a method for controlling a hybrid vehicle according to the present invention, the hybrid vehicle includes an internal combustion engine, a first motor generator which generates electric power through driving of the internal combustion engine, a second motor generator which drives the hybrid vehicle and generates electric power through regenerative braking, a power storage device which is configured to enable supply and reception of electric power between the first motor generator and the second motor generator, and a selector for selecting a regeneration level of the second motor generator. The method for controlling a hybrid vehicle includes the steps of receiving selection of the regeneration level by a driver through the selector and maintaining a regeneration level of the second motor generator at a default level when a regeneration level is not selected by the selector, setting a charging amount from the first motor generator to the power storage device during operation of the internal combustion engine to be larger in a case where a regeneration level lower than a default level is selected by the selector than in a case where a regeneration level is not selected by the selector, and increasing a power generation amount of the second motor generator by setting a regenerative braking force generated by the second motor generator during an off-state of an accelerator to be larger in a case where the regeneration level is high than in a case where the regeneration level is low.

With the configuration described above, when a regeneration level lower than a default level is selected, starting of the internal combustion engine due to a small recovery amount of the remaining capacity of the power storage device in the off-state of an accelerator can be prevented.

According to the present invention described above, deterioration of fuel consumption due to setting a low regeneration level can be prevented.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 represents a configuration of a hybrid vehicle according to an embodiment of the present invention.

FIG. 2 is a diagram for description of an electrical system for the hybrid vehicle.

FIG. 3 represents a relationship between levels selected by a regeneration level selector and a regenerative braking force according to an embodiment of the present invention.

FIG. 4 represents constituent elements related to regenerative control and charging control of an ECU.

FIG. 5 represents a relationship between an SOC of a battery and a requested charging/discharging amount of a battery as defined by a charging/discharging map.

FIG. 6 is a diagram for description of operating points of an engine.

FIG. 7 is a flowchart representing procedures of calculation of a requested charging amount and regenerative control according to an embodiment of the present invention.

FIG. 8 is a diagram for description of a control sequence according to an embodiment of the present invention.

FIG. 9 represents a relationship between levels selected by the regeneration level selector and a regenerative braking force according to a modified example.

### DESCRIPTION OF THE PREFERRED EMBODIMENT

Hereinafter, an embodiment of the present invention will be described with reference to the drawings. In the following description, the same parts are denoted with the same reference numerals. Their designations and functions are also the same. Therefore, a detailed description thereof will not be repeated.

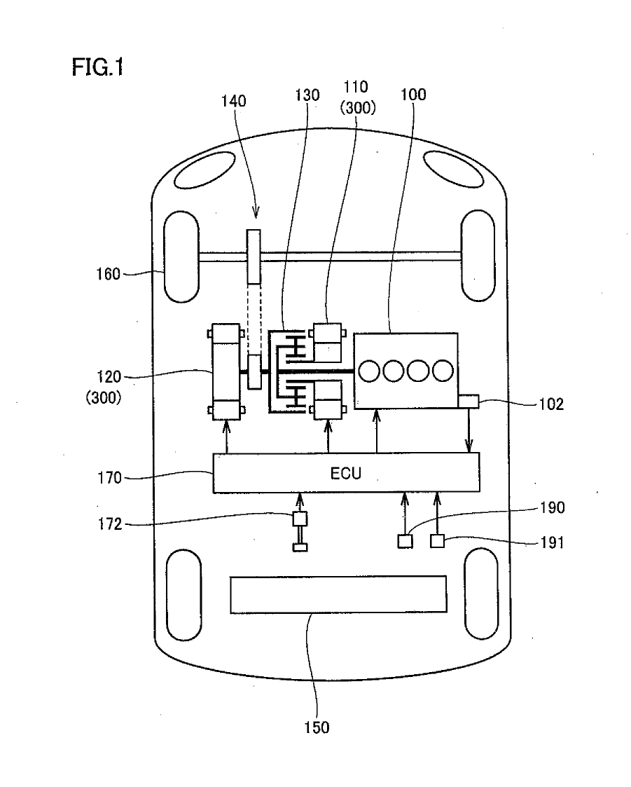

FIG. 1 represents a configuration of a hybrid vehicle according to an embodiment of the present invention.

Referring to FIG. 1, a hybrid vehicle is equipped with an engine 100, a first motor generator 110, a second motor generator 120, a power split mechanism 130, a speed reducer 140, and a battery 150. First motor generator 110 and second motor generator 120 constitute a motor generator unit 300.

It should be noted that a hybrid vehicle that does not have a function of charging from an external power source is described in the following description by way of example. However, a plug-in hybrid vehicle, which has the function of charging from an external power source, may be employed.

Engine 100, first motor generator 110, second motor generator 120, and battery 150 are controlled by an ECU (Electronic Control Unit) 170. ECU 170 may be divided into a plurality of ECUs.

The hybrid vehicle runs using a driving force from at least one of engine 100 and second motor generator 120. More specifically, either one or both of engine 100 and second motor generator 120 are automatically selected as a driving source depending on an operation state.

For example, engine 100 and second motor generator 120 are controlled in accordance with a result of a driver's operation on an accelerator pedal 172. An amount of operation on accelerator pedal 172 (accelerator position) is detected by an accelerator position sensor (not shown).

When the accelerator position is small and the vehicle speed is low, the hybrid vehicle runs using only second motor generator 120 as a driving source. In this case, engine 100 is stopped. However, engine 100 is sometimes driven, for example, for power generation.

On the other hand, when the accelerator position is large, when the vehicle speed is high, or when the state of charge (SOC) of battery 150 is small, engine 100 is driven. In this case, the hybrid vehicle runs on only engine 100 or both of engine 100 and second motor generator 120 as a driving source.

Engine 100 is an internal combustion engine. The temperature of air taken into engine 100 is detected by a temperature sensor 102 and inputted to ECU 170. Engine 100, first motor generator 110, and second motor generator 120 are coupled to an output shaft (crank shaft) 108 of engine 100 through power split mechanism 130. The motive power generated by engine 100 is split into two paths by power split mechanism 130. One path is a path for driving front wheels 160 through speed reducer 140. The other path is a path for generating electric power by driving first motor generator 110.

First motor generator 110 is a three-phase alternating current rotating electric machine including a U-phase coil, a V-phase coil, and a W-phase coil. First motor generator 110 generates electric power using the motive power of engine 100 that is split by power split mechanism 130. The electric power generated by first motor generator 110 is used depending on the running state of the vehicle and an SOC (state of charge) of battery 150. For example, in the normal running, electric power generated by first motor generator 110 is directly used as electric power for driving second motor generator 120. On the other hand, when the SOC of battery 150 is lower than a predetermined value, electric power generated by first motor generator 110 is converted from alternating current to direct current by an inverter described later. Thereafter, the voltage is adjusted by a converter described later and then stored in battery 150.

When first motor generator 110 acts as a power generator, first motor generator 110 generates negative torque. Here, the negative torque refers to such torque that becomes a load on engine 100. When first motor generator 110 receives power supply and acts as a motor, first motor generator 110 generates positive torque. Here, the positive torque refers to such torque that does not become a load on engine 100, that is, such torque that assists in rotation of engine 100. This is applicable to second motor generator 120.

Second motor generator 120 is a three-phase alternating current rotating electric machine including a U-phase coil, a V-phase coil, and a W-phase coil. Second motor generator 120 is driven using at least one of electric power stored in battery 150 and electric power generated by first motor generator 110.

Driving force of second motor generator 120 is transmitted to front wheels 160 through speed reducer 140. Accordingly, second motor generator 120 assists engine 100 or allows the vehicle to run with the driving force from second motor generator 120. The rear wheels may be driven in place of or in addition to front wheels 160.

At the time of reducing a speed during an off-state of an accelerator (an accelerator position is 0), second motor generator 120 is driven by front wheels 160 through speed reducer 140, so that second motor generator 120 operates as a power generator. Thus, second motor generator 120 operates as a regenerative brake which converts braking energy into electric power. Second motor generator 120 sets regenerative torque in accordance with a selected regeneration level to provide a regenerative braking force in accordance with the selected regeneration level. The electric power generated by second motor generator 120 is stored in battery 150.

Power split mechanism 130 is formed of a planetary gear including a sun gear, pinion gears, a carrier, and a ring gear. The pinion gears are engaged with the sun gear and the ring gear. The carrier supports the pinion gears such that they are rotatable on their own axes. The sun gear is coupled to the rotation shaft of first motor generator 110. The carrier is coupled to the crankshaft of engine 100. The ring gear is coupled to a rotation shaft of second motor generator 120 and speed reducer 140.

Turning back to FIG. 1, battery 150 is a battery pack configured such that a plurality of battery modules, each formed by integrating a plurality of battery cells, are connected in series. The voltage of battery 150 is, for example, about 200 V. Battery 150 is charged with electric power supplied from first motor generator 110 and second motor generator 120 as well as a power source external to the vehicle. A capacitor may be used in place of or in addition to battery 150.

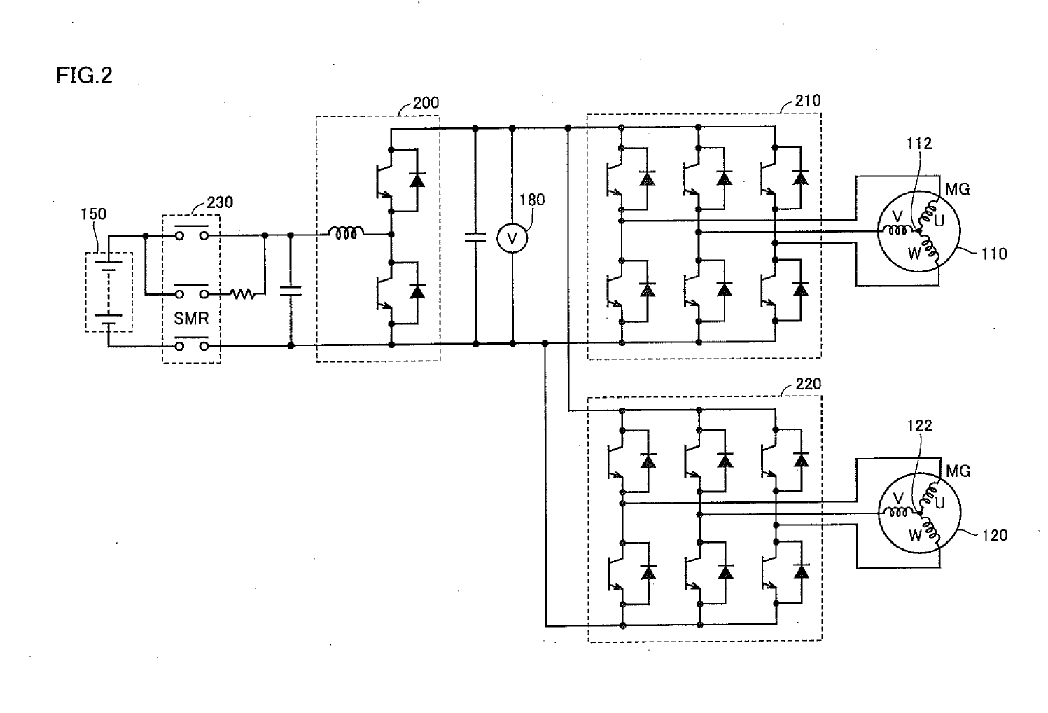

Referring to FIG. 2, the electrical system of the hybrid vehicle will be further described. A hybrid vehicle is provided with a converter 200, a first inverter 210, a second inverter 220, and a system main relay 230.

Converter 200 includes a reactor, two npn transistors, and two diodes. The reactor has one end connected to the positive electrode side of each battery and has the other end connected to a node between the two npn transistors.

The two npn transistors are connected in series. The npn transistors are controlled by ECU 170. A diode is connected between the collector and the emitter of each npn transistor to allow current to flow from the emitter side to the collector side.

As the npn transistor, for example, an IGBT (Insulated Gate Bipolar Transistor) can be used. In place of the npn transistor, a power switching element such as a power MOSFET (Metal Oxide Semiconductor Field-Effect Transistor) can be used.

When electric power discharged from battery 150 is supplied to first motor generator 110 or second motor generator 120, the voltage is boosted by converter 200. Conversely, when electric power generated by first motor generator 110 or second motor generator 120 is supplied to charge battery 150, the voltage is decreased by converter 200.

A system voltage VH between converter 200 and each inverter is detected by a voltage sensor 180. The detection result from voltage sensor 180 is sent to ECU 170.

First inverter 210 includes a U-phase arm, a V-phase arm, and a W-phase arm. The U-phase arm, the V-phase arm, and the W-phase arm are connected in parallel. Each of the U-phase arm, the V-phase arm, and the W-phase arm has two npn transistors connected in series. A diode is connected between the collector and the emitter of each npn transistor to allow current to flow from the emitter side to the collector side. Then, the node between the npn transistors in each arm is connected to the end different from a neutral point 112 of each coil of first motor generator 110.

First inverter 210 converts direct current supplied from battery 150 into alternating current, and supplies the alternating current to first motor generator 110. First inverter 210 converts alternating current generated by first motor generator 110 into direct current.

Second inverter 220 includes a U-phase arm, a V-phase arm, and a W-phase arm. The U-phase arm, the V-phase arm, and the W-phase arm are connected in parallel. Each of the U-phase arm, the V-phase arm, and the W-phase arm has two npn transistors connected in series. A diode is connected between the collector and the emitter of each of the npn transistors to allow current to flow from the emitter side to the collector side. Then, the node between the npn transistors in each arm is connected to the end different from neutral point 122 of each coil of second motor generator 120.

Second inverter 220 converts direct current supplied from battery 150 into alternating current and supplies the alternating current to second motor generator 120. Second inverter 220 converts the alternating current generated by second motor generator 120 into direct current.

Converter 200, first inverter 210, and second inverter 220 are controlled by ECU 170.

System main relay 230 is provided between battery 150 and converter 200. System main relay 230 is a relay for switching between a state in which battery 150 and the electrical system are connected to each other and a state in which battery 150 and the electrical system are disconnected from each other. When system main relay 230 is in an open state, battery 150 is disconnected from the electrical system. When system main relay 230 is in a close state, battery 150 is connected to the electrical system.

The state of system main relay 230 is controlled by ECU 170. For example, when ECU 170 is activated, system main relay 230 is closed. When ECU 170 is stopped, system main relay 230 is opened.

A regeneration level selector 190 selects a regeneration level in accordance with a user's operation. In the embodiment of the present invention, the regeneration level has, for example, six levels of 0 to 5. As the regeneration level is lower, a regenerative braking force generated by second motor generator 120 is smaller.

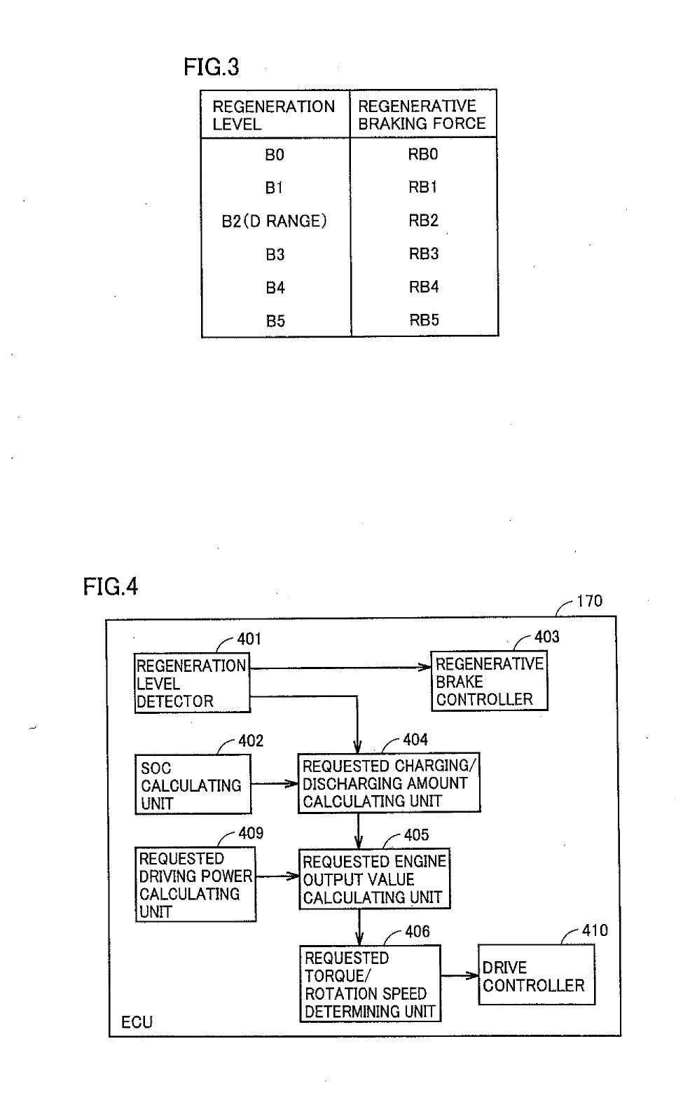

FIG. 3 represents a relationship between levels selected by the regeneration level selector and the regenerative braking force.

When the regeneration level B0, B1, B2, B3, B4, or B5 is selected by regeneration level selector 190, the regenerative braking is operated during an off-state of the accelerator with the regenerative braking force of RB0, RB1, RB2, RB3, RB4, or RB5. Here, RB0<RB1<RB2<RB3<RB4<RB5 is provided. Regeneration level B2 is a default level. When a D range (forward movement) is selected by a select bar 191, and a regeneration level is not selected by regeneration level selector 190, the regeneration level is maintained at default level B2.

FIG. 4 represents constituent elements related to regenerative control and charging control of ECU 170.

ECU 170 includes a regeneration level detector 401, a regenerative braking controller 403, an SOC calculating unit 402, a requested charging/discharging amount calculating unit 404, a requested driving power calculating unit 409, a requested engine output value calculating unit 405, a requested torque/rotation speed determining unit 406, and a drive controller 410.

Regeneration level detector 401 detects a regeneration level selected by regeneration level selector 190.

SOC calculating unit 402 calculates an SOC (State Of Charge) representing a remaining capacity of battery 150 based on a voltage VB of battery 150 and a current IB inputted to and outputted from battery 150. Voltage VB and current IB are detected respectively by a voltage sensor and a current sensor which are not illustrated in the drawings.

Requested charging/discharging amount calculating unit 404 calculates a requested charging/discharging amount of battery 150 based on the SOC of battery 150 with use of a predefined charging/discharging map.

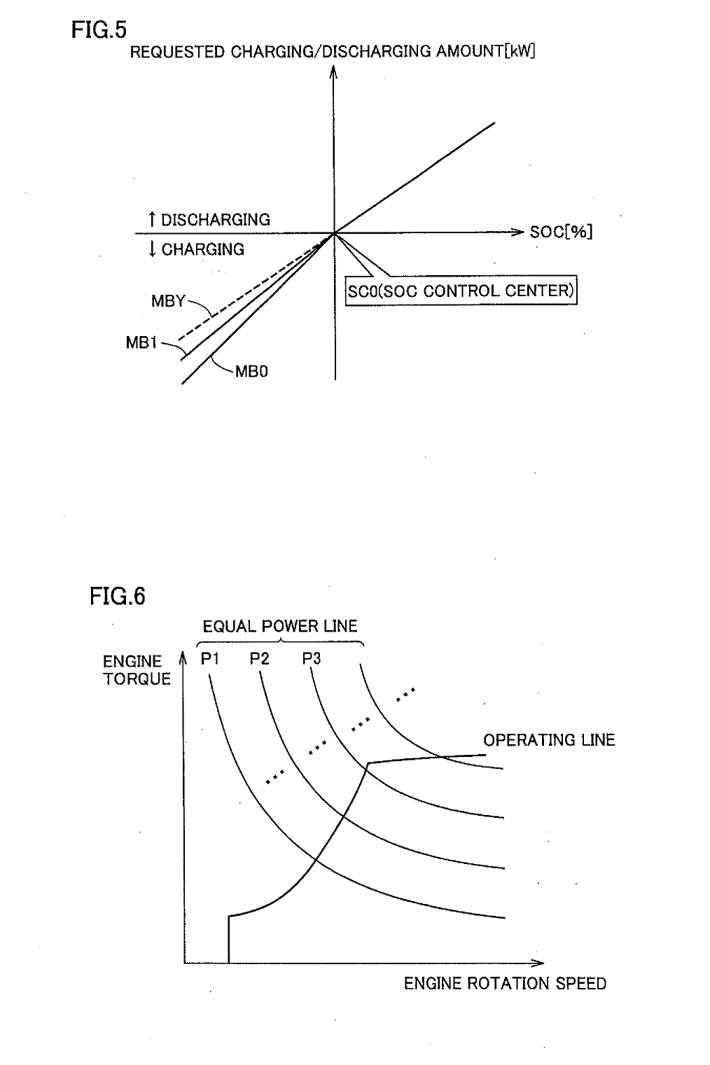

FIG. 5 represents a relationship between the SOC of battery 150 and the requested charging/discharging amount defined by the charging/discharging map.

When the SOC is higher than a predetermined value SC0, electric power is outputted from battery 150. When the SOC is smaller than predetermined value SC0, electric power is supplied to battery 150. When the SOC is equal to predetermined value SC0, a charging amount of battery 150 in the present state is maintained.

The requested discharging amount is not changed depending on the selected regeneration level. With SC0 as a control center, the requested discharging amount is set larger in proportion to the SOC.

The requested charging amount is changed depending on the selected regeneration level. With SC0 as a control center, the requested charging amount is set larger in proportion to the SOC. In the case where the accelerator is in the on-state (in other words, the accelerator position is other than 0), and engine 100 is in operation, and when regeneration level B0 is selected, requested charging/discharging amount calculating unit 404 calculates the requested charging amount with respect to the SOC based on a map MB0. In the case where the accelerator is in the on-state, and engine 100 is in operation, and when regeneration level B1 is selected, requested charging/discharging amount calculating unit 404 calculates the requested charging amount with respect to the SOC based on a map MB1. In the case where the accelerator is in the on-state, and engine 100 is in operation, and when regeneration level B2, B3, B4, or B5 is selected, requested charging/discharging amount calculating unit 404 calculates the requested charging amount with respect to the SOC based on a map MBY. With respect to the same SOC, there is a relationship of the requested charging amount based on map MB0> the requested charging amount based on map MB1> the requested charging amount based on map MBY.

Requested driving power calculating unit 409 calculates requested driving power of a vehicle based on an accelerator position and a vehicle speed. The requested driving power does not change depending on the selected regeneration level.

Requested engine output value calculating unit 405 adds the requested driving power and the requested charging/discharging amount to calculate the requested engine output value. Requested engine output value calculating unit 405 changes the requested engine output value so that the requested driving power does not change depending on the selected regeneration level. Specifically, requested engine output value calculating unit 405 sets the requested engine output value to be larger in the case where regeneration level B0 or B1 is selected than in the case where any one of regeneration levels B2 to B5 is selected by a difference in the requested charging amount between the requested charging amount for the case where regeneration level B0 or B1 is selected and the requested charging amount for the case where any one of regeneration levels B2 to B5 is selected.

Requested torque/rotation speed determining unit 406 determines the engine rotation speed and the engine torque with respect to the requested engine output value.

As shown in FIG. 6, the operating point of engine 100, specifically an engine rotation speed NE and engine torque TE are determined in accordance with an intersection between the requested engine output value and the operating line. The requested engine output value is indicated by equal power lines P1, P2, P3, and so on. The operating line is determined in advance by a developer based on the results of experiments and simulations. The operating line is set so that engine 100 can be driven with optimal (minimum) fuel consumption. That is, the optimal fuel consumption is achieved by driving engine 100 along the operating line.

Drive controller 410 controls first motor generator 110, converter 200, and first inverter 210 so that battery 150 can be charged and discharged during operation of engine 100 by the requested charging/discharging amount calculated by charging/discharging amount calculating unit 404.

Drive controller 410 controls engine 100 so that the engine rotation speed and the engine torque determined by the requested torque/rotation speed determining unit 406 can be achieved during operation of engine 100. Drive controller 410 controls power split mechanism 130, first motor generator 110, converter 200, first inverter 210, second motor generator 120, and second inverter 220 so that the requested driving power calculated by requested driving power calculating unit 409 can be achieved during operation of engine 100.

Regenerative braking controller 403 calculates the regenerative torque necessary for generation of a regenerative braking force in accordance with the regeneration level detected by regeneration level detector 401 during the off-state of the accelerator (in other words, when the accelerator position is 0%). Regenerative braking controller 403 controls converter 200, second inverter 220, and second motor generator 120 so that the regenerative braking is operated in accordance with the calculated regenerative torque.

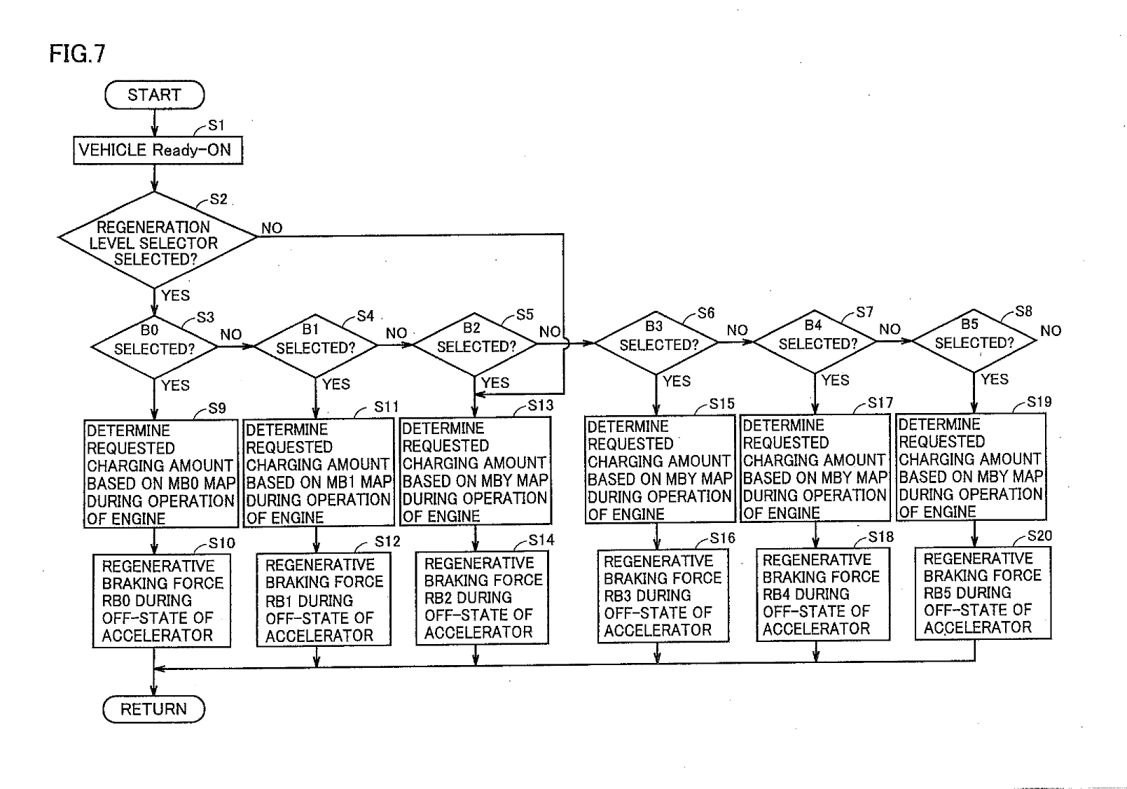

FIG. 7 is a flowchart representing procedures of calculation of the requested charging amount and regenerative control according to the embodiment of the present invention.

In step S1, a power switch and a foot brake which are not illustrated in the drawings are operated, so that the hybrid vehicle is set to a Ready-ON state as a state in which preparation for running is completed.

In step S2, in the case where a user operates regeneration level selector 190 to select any of the regeneration levels, the process proceeds to step S3.

In step S3, when regeneration level B0 is selected by regeneration level selector 190, the process proceeds to step S9. In step S4, when regeneration level B1 is selected by regeneration level selector 190, the process proceeds to step S11. In step S5, when regeneration level B2 is selected by regeneration level selector 190, the process proceeds to step S13. In step S6, when regeneration level B3 is selected by regeneration level selector 190, the process proceeds to step S15. In step S7, when regeneration level B4 is selected by regeneration level selector 190, the process proceeds to step S17. In step S8, when regeneration level B5 is selected by regeneration level selector 190, the process proceeds to step S19. Further, also in the case where a user does not operate regeneration level selector 190 in step S2, the process proceeds to step S13.

In step S9, specifically, in the case where regeneration level B0 is selected, and when the accelerator is in the on-state, and engine 100 operates, requested charging/discharging amount calculating unit 404 calculates a requested charging amount corresponding to the SOC in accordance with the MB0 map as shown in FIG. 5.

In step S11, specifically, in the case where regeneration level B1 is selected, and when the accelerator is in the on-state, and engine 100 operates, requested charging/discharging amount calculating unit 404 calculates a requested charging amount corresponding to the SOC in accordance with the MB1 map as shown in FIG. 5.

In steps S13, S15, S17, and S19, specifically, in the case where regeneration level B2, B3, B4, or B5 is selected, and when the accelerator is in the on-state, and engine 100 operates, requested charging/discharging amount calculating unit 404 calculates a requested charging amount corresponding to the SOC in accordance with the MBY map as shown in FIG. 5.

In step S10, specifically, when level B0 is selected, regenerative braking controller 403 operates a regenerative brake with regenerative braking force RB0 corresponding to regeneration level B0 during the off-state of the accelerator.

In step S12, specifically, when level B1 is selected, regenerative braking controller 403 operates a regenerative brake with regenerative braking force RB1 corresponding to regeneration level B1 during the off-state of the accelerator.

In step S14, specifically, when level B2 is selected, regenerative braking controller 403 operates a regenerative brake with regenerative braking force RB2 corresponding to regeneration level B2 during the off-state of the accelerator.

In step S16, specifically, when level B3 is selected, regenerative braking controller 403 operates a regenerative brake with regenerative braking force RB3 corresponding to regeneration level B3 during the off-state of the accelerator.

In step S18, specifically, when level B4 is selected, regenerative braking controller 403 operates a regenerative brake with regenerative braking force RB4 corresponding to regeneration level B4 during the off-state of the accelerator.

In step S20, specifically, when level B5 is selected, regenerative braking controller 403 operates a regenerative brake with regenerative braking force RB5 corresponding to regeneration level B5 during the off-state of the accelerator.

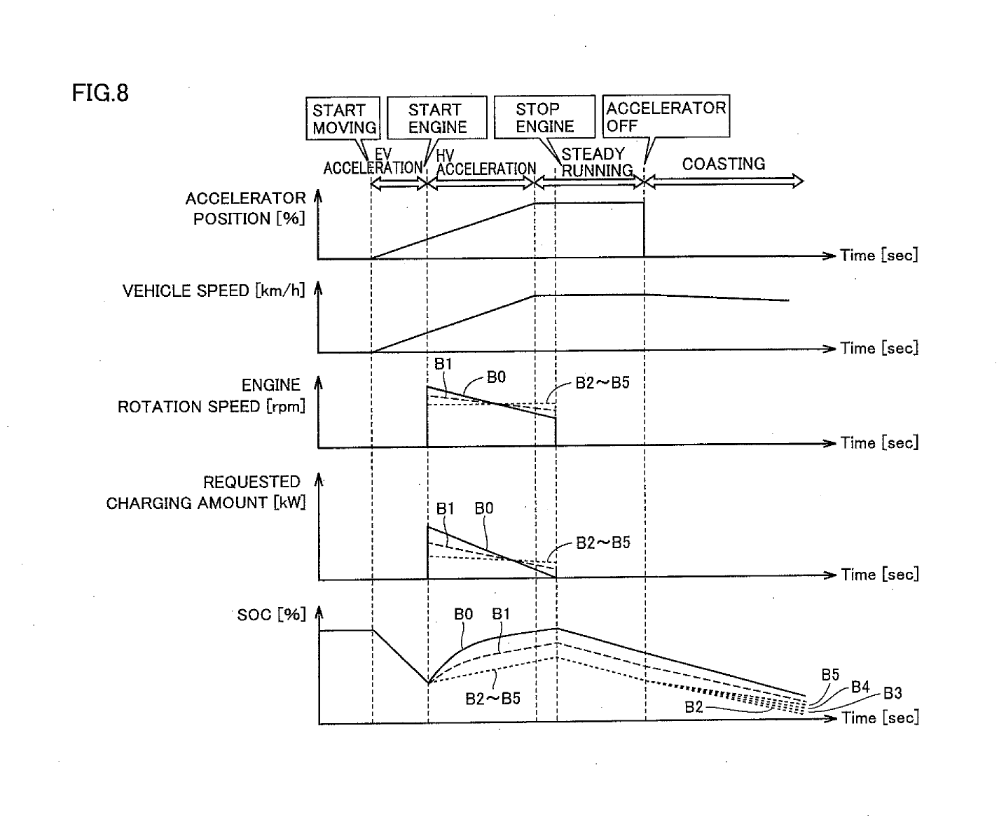

FIG. 8 is a diagram for description of a control sequence according to the embodiment of the present invention.

When the accelerator is turned on and the vehicle starts moving, EV acceleration is firstly performed. Specifically, since engine 100 is not efficient when the vehicle starts moving, drive controller 410 does not start engine 100 and performs driving of the vehicle only with second motor generator 120. Second motor generator 120 is driven by electric power stored in battery 150. This lowers the SOC of battery 150.

Next, when the vehicle speed increases, HV acceleration is performed so that greater torque can be outputted. Specifically, drive controller 410 starts engine 100 to perform driving of the vehicle with engine 100 and second motor generator 120. Requested charging/discharging amount calculating unit 404 calculates a requested charging/discharging amount of battery 150 based on the SOC (State Of Charge) of battery 150 and a selected regeneration level. In the initial stage of the HV acceleration, since a difference in the SOC by the selected regeneration level is small, the requested charging amount is the largest in the case where the selected regeneration level is B0, the next largest in the case where the selected regeneration level is B1, and the smallest in the case where the regeneration level is any one of B2 to B5. After that, as the SOC increases, the requested charging amount is reduced in any regeneration level. However, the amount of increase in the SOC is the largest in the case where the selected regeneration level is B0, the next largest in the case where the selected regeneration level is B1, and the smallest in the case where the selected regeneration level is any one of B2 to B5. Accordingly, the size relation of the requested charging amount is changed. Specifically, the requested charging amount is the largest in the case where the selected regeneration level is any one of B2 to B5, the next largest in the case where the selected regeneration level is B1, and the smallest in the case where the selected regeneration level is B0.

Further, when the selected regeneration level is any one of B2 to B5 during the HV acceleration, drive controller 410 maintains the engine rotation speed to be constant. In the initial stage of the HV acceleration, drive controller 410 sets an engine output value in the case where the regeneration level is B0 or B1 to be larger than an engine output value in the case where the selected regeneration level is any one of B2 to B5 so that driving power of the vehicle in the case where the selected regeneration level is B0 or B1 becomes equal to driving power in the case where the selected regeneration level is any one of B2 to B5. This is because the requested charging amount in the case where the selected regeneration level is B0 or B1 is larger than the requested charging amount in the case where the selected regeneration level is any one of B2 to B5. On that account, in the initial stage of the HV acceleration, drive controller 410 sets the engine rotation speed and engine torque in the case where the selected regeneration level is B0 or B1 to be larger than the engine rotation speed and engine torque in the case where the selected regeneration level is any one of B2 to B5.

After that, since the requested charging amount in the case where the selected regeneration level is B0 or B1 becomes smaller than the requested charging amount in the case where the regeneration level is any one of B2 to B5, drive controller 410 sets the engine output value in the case where the selected regeneration level is B0 or B1 to be smaller than the engine output value in the case where the selected regeneration level is any one of B2 to B5 so that the driving power of the vehicle in the case where the selected regeneration level is B0 or B1 becomes equal to the driving power in the case where the selected regeneration is any one of B2 to B5. On that account, in accordance with the operating line of FIG. 6, drive controller 410 sets the engine rotation speed and engine torque in the case where the selected regeneration level is B0 or B1 to be smaller than the engine rotation torque speed and engine torque in the case where the selected regeneration level is any one of B2 to B5.

Next, when the accelerator position is fixed, the vehicle speed is fixed. Further, engine 100 is stopped, and steady running is performed.

When engine 100 is stopped, the SOC is the largest in the case where the selected regeneration level is B0, the next largest in the case where the regeneration level is B1, and the smallest in the case where the selected regeneration level is any one of B2 to B5. Specifically, during operation of engine 100 (that is the period from starting to stopping), the charging amount from first motor generator 110 to battery 150 is the largest in the case where the selected regeneration level is B0, the next largest in the case where the selected regeneration level is B1, and the smallest in the case where the selected regeneration level is B2.

During the steady running, drive controller 410 does not operate engine 100, and performs driving only with second motor generator 120. Accordingly, the SOC of battery 150 is lowered.

Next, when the accelerator is turned off, the accelerator position becomes 0%, and the vehicle undergoes the coasting state. Regenerative braking controller 403 operates the regenerative brake with the regenerative braking force in accordance with the selected regeneration level. Under the coasting state, the SOC of battery 150 is reduced due to the use of an auxiliary machine such as an air conditioner. However, the reduction of the SOC can be supplemented by the regenerative electric power generation of the regenerative brake. As the selected regeneration level becomes higher, the regenerative braking force becomes larger, so that the amount of regenerative electric power generated by second motor generator 120 increases. Thus, under the coasting state, the amount of lowering of the SOC increases as the selected regeneration level is lower. FIG. 8 shows that the gradient of the straight line indicating the lowering of the SOC is the largest at regeneration level B0, and the gradient of the straight line becomes smaller in the order of B1, B2, B3, B4, and B5.

In the case where the regeneration level is B0 or B1, the SOC is increased during the on-state of the accelerator. Therefore, even when the recovery amount of the SOC during the off-state of the accelerator is small, the SOC can be prevented from becoming smaller to the extent of starting engine 100.

### Modified Example

The present invention is not limited to the embodiment described above.

Description will be made on the case where the regeneration level which can be selected by regeneration level selector 190 is limited to be smaller than the default regeneration level (the regeneration level in the D range).

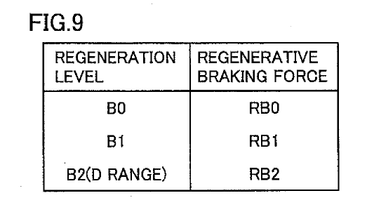

FIG. 9 represents a relationship between the levels selected by regeneration level selector 190 and the regenerative braking force in the present modified example.

When regeneration level B0 or B1 is selected by regeneration level selector 190, the regenerative brake is operated respectively with regenerative braking force RB0 or RB1 during the off-state of the accelerator. When the D range (forward movement) is selected by select bar 191, and the regeneration level is not selected by regeneration level selector 190, the regeneration level is maintained at default level B2. At default level B2, the regenerative brake is operated with regenerative braking force RB2 during the off-state of the accelerator. Here, RB0<RB1<RB2 is met.

Drive controller 410 sets the charging amount from first motor generator 110 to battery 150 during operation of engine 100 to be larger in the case where regeneration level B0 or B1 is selected by regeneration level selector 190 than in the case where the regeneration level is not selected by regeneration level selector 190. Further, drive controller 410 sets the charging amount from first motor generator 110 to battery 150 during operation of engine 100 to be larger in the case where regeneration level B0 is selected by regeneration level selector 190 than the case where regeneration level B1 is selected.

Regenerative braking controller 403 sets the regenerative braking force by the second motor generator during the off-state of the accelerator to be larger in the case where the regeneration level is not selected by regeneration level selector 190 than in the case where regeneration level B0 or B1 is selected by regeneration level selector 190, thereby increasing the charging amount to battery 150. Further, regenerative braking controller 403 sets the regenerative braking force of the second motor generator during the off-state of the accelerator to be larger in the case where regeneration level B1 is selected by regeneration level selector 190 than in the case where regeneration level B0 is selected, thereby increasing the charging amount to battery 150.

### Modified Examples

The present invention is not limited to the embodiment described above, and also includes the following modified examples.

(1) Series Type

The present invention can be also applied to a hybrid vehicle of a series type. Specifically, in the series type, the engine drives the first motor generator (power generator), and the generated electric power is stored in the battery. The second motor generator is driven by the electric power of the battery, so that a vehicle runs.

Also in this series-type hybrid vehicle, the ECU sets the power generation amount of the second motor generator to be larger by setting the regenerative braking force by the second motor generator during the off-state of the accelerator to be larger in the case where the regeneration level selected by the regeneration level selector is high than the case where the selected regeneration level is low. The ECU sets the charging amount from the first generator to the power storage during operation of the engine to be larger in the case where the regeneration level lower than the default level is selected by the regeneration level selector than in the case where the regeneration level is not selected by the regeneration level selector.

(2) Single Motor Type

Further, in the single motor type where a single motor generator A performs both regenerative electric power generation and power generation during operation of an engine, the following control may be performed.

In the single motor type, an ECU sets the regenerative braking force by motor generator A during the off-state of the accelerator to be larger in the case where the regeneration level selected by the regeneration level selector is high than in the case where the selected regeneration level is low, thereby increasing the amount of electric power generation by motor generator A. The ECU sets the charging amount from motor generator A to the power storage during operation of the engine to be larger in the case where the regeneration level lower than the default level is selected by the regeneration level selector than in the case where the regeneration level is not selected by the regeneration level selector.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A hybrid vehicle, comprising:
an internal combustion engine;
a first motor generator which generates electric power through driving of said internal combustion engine;
a second motor generator which drives said hybrid vehicle and generates electric power through regenerative braking;
a power storage device which is configured to enable supply and reception of electric power between said first motor generator and said second motor generator;
a selector which selects a regeneration level of said second motor generator in accordance with a driver's operation, a regeneration level of said second motor generator being maintained at a default level when a regeneration level is not selected by said selector; and
a control device which increases a power generation amount of said second motor generator by setting a regenerative braking force generated by said second motor generator during an off-state of an accelerator to be larger in a case where said regeneration level is high than in a case where said regeneration level is low,
said control device setting a charging amount from said first motor generator to said power storage device during operation of said internal combustion engine to be larger in a case where a regeneration level lower than a default level is selected by said selector than in a case where a regeneration level is not selected by said selector.

2. The hybrid vehicle according to claim 1, wherein under a condition that a remaining capacity of said power storage device is equal, said control device setting a requested charging amount of said power storage device during operation of said internal combustion engine to be larger in a case where a regeneration level lower than a default level is selected by said selector than in a case where a regeneration level is not selected by said selector.

3. The hybrid vehicle according to claim 1, wherein in a case where a plurality of regeneration levels lower than said default level are provided which can be selected by said selector, and said plurality of regeneration levels include a first level and a second level higher than said first level,
said control device sets a charging amount from said first motor generator to said power storage device during operation of said internal combustion engine to be larger in a case where said first level is selected than in a case where said second level is selected.

4. The hybrid vehicle according to claim 1, wherein said control device changes an output of said internal combustion engine in accordance with said selected regeneration level so that a driving force of said hybrid vehicle does not change in accordance with said selected regeneration level during operation of said internal combustion engine.

5. The hybrid vehicle according to claim 1, further comprising a power split mechanism which is configured to distribute a driving force from said internal combustion engine to said first motor generator and a drive shaft of a vehicle, wherein
said first motor generator can generate electric power by receiving a driving force from said internal combustion engine, and
said second motor generator is coupled to said drive shaft.

6. A method for controlling a hybrid vehicle,
said hybrid vehicle including:
an internal combustion engine;
a first motor generator which generates electric power through driving of said internal combustion engine;
a second motor generator which drives said hybrid vehicle and generates electric power through regenerative braking;
a power storage device which is configured to enable supply and reception of electric power between said first motor generator and said second motor generator; and
a selector for selecting a regeneration level of said second motor generator,
said method for controlling a hybrid vehicle comprising the steps of:
receiving selection of said regeneration level by a driver through said selector and maintaining a regeneration level of said second motor generator at a default level when a regeneration level is not selected by said selector;
setting a charging amount from said first motor generator to said power storage device during operation of said internal combustion engine to be larger in a case where a regional level lower than a default level is selected by said selector than in a case where a regeneration level is not selected by said selector; and
increasing a power generation amount of said second motor generator by setting a regenerative braking force generated by said second motor generator during an off-state of an accelerator to be larger in a case where said regeneration level is high than in a case where said regeneration level is low.
